(19) United States
(12) Patent Application Publication
(10) Pub. No.: US 2021/0304213 A1
(43) Pub. Date: Sep. 30, 2021

(54) SYSTEM AND METHOD OF SHARING INFORMATION BETWEEN ENTITIES TO ENABLE A TRANSACTION

(71) Applicant: Amod Ashok Dange, Mountain View, CA (US)

(72) Inventors: Amod Ashok Dange, Mountain View, CA (US); Yash Mody, Mumbai (IN)

(21) Appl. No.: 17/166,148

(22) Filed: Feb. 3, 2021

Related U.S. Application Data
(60) Provisional application No. 63/002,381, filed on Mar. 31, 2020.
(60) Provisional application No. 63/001,314, filed on Mar. 28, 2020.

(51) Int. Cl. G06Q 20/42; G06Q 20/38; G06F 16/21

(52) U.S. Cl. CPC G06Q 20/42; G06F 16/213; G06Q 20/388

(57) ABSTRACT

A system and method of sharing information between entities to enable a transaction. The system may enable a super-schema library corresponding to a set of entities. The system may receive a first request from a first entity to initiate a transaction with a second entity. The system may then transmit the request to the second entity. Further, the system may receive a second request, from the second entity, to access a dataset corresponding to the first entity. The system may then transmit to the second entity, data from the dataset corresponding to the first entity. Further, the second entity may be configured to enable a transaction interface configured to render a target sub-schema and enable the second entity to execute a target action based on the data from the dataset associated with the second entity and the first entity, using the target sub-schema.

### CROSS-REFERENCE TO RELATED APPLICATIONS AND PRIORITY

The present application claims priority from U.S. Provisional application No. 63/001,314 filed on Mar. 28, 2020 entitled “Method of using shared schemas to enable interoperability across systems and devices” and also claims priority from U.S. Provisional application No. 63/002,381 filed on Mar. 31, 2020 entitled “Method of managing human network information.”

### TECHNICAL FIELD

The present subject matter described herein, in general, relates to a system and a method of enabling transaction between two or more entities. More specifically, the present subject matter discloses the system and the method of sharing information between entities to enable a transaction.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

We live in a world full of systems and devices of numerous kinds. Each system or device capable of communicating or storing data uses database schemas. A database schema is the hierarchical organization of data elements that serves as a blueprint of how the database is constructed. The database schema states the explicit mapping of how data is modelled in the database. Typically, each system or device uses a database schema unique to itself. Therefore, two randomly selected devices of different kinds have different data structures for data management and are incapable of communicating with each other unless and until an intermediate platform is enabled to transform data from one database schema to another.

This is true irrespective of the devices being hardware, software, or a combination of hardware and software. A considerable amount of human intervention is required while establishing communication between such devices.

This problem of establishing communication between such devices is exacerbated, when it comes to interaction of a user with another user over the internet using various devices. Furthermore, due to data privacy and access control requirements, the traditional client-server architecture of the internet has led to several structural flaws in the human communication network. In order to establish communication between two users, profile-based access is enabled in the art. As the number of profiles increases, it becomes increasingly more difficult to manage these profiles. On average, an online user has 7.6 social media accounts. Many of these online profiles are created using inauthentic identities. An estimated 30% of profiles on social media are based on inauthentic identities. User privacy is also at risk as different applications have different privacy standards.

There are many AI-powered Personal Assistants in the market, such as Google Assistant, Siri, and Alexa. These tools provide users with highly personalized services. Over time, the personal assistant knows more about the users they serve than the users themselves. The corporations that build the personal assistants claim that the assistants use people's personal data in a responsible manner. However, there have been numerous instances wherein personal data associated with users has been leaked.

Clearly, the need for sharing information between two entities is currently only met by placing unreasonable trust in corporations

The current invention provides a way to share information while applying fine-grained privacy settings, powering applications with all the information they need while maintaining appropriate privacy controls at all times.

### SUMMARY

This summary is provided to introduce concepts related to a system and a method of sharing information pertaining to one entity, with another entity, to enable transaction between two entities, and the concepts are further described below in the detailed description. This summary is not intended to identify essential features of the claimed subject matter nor is it intended for use in determining or limiting the scope of the claimed subject matter.

In one implementation, a system for sharing information between entities to enable a transaction, is illustrated in accordance with an embodiment of the invention. The system comprises a processor and a memory coupled to the process. The processor is configured to execute program instructions stored in the memory to enable a super-schema library corresponding to a set of entities. The super-schema library is configured to maintain a set of schemas, wherein each schema comprises a set of sub-schemas. Each sub-schema, from the set of sub-schemas, corresponds to a dataset associated with an entity. The dataset comprises data corresponding to each role, from a set of roles, associated with the entity. The processor may execute program instructions stored in the memory to receive a first request from a first entity to initiate a transaction with a second entity. Upon receipt of the first request, the processor may execute program instructions stored in the memory to transmit the request to the second entity. Further, the processor may execute program instructions stored in the memory to receive a second request, from the second entity, to access a dataset corresponding to the first entity, wherein the second request comprises a candidate role defining the relationship between the first entity and the second entity. Further, the processor may execute program instructions stored in the memory to determine a candidate sub-schema from the super-schema library based on the candidate role, wherein the candidate sub-schema is associated with the first entity. Further, the processor may execute program instructions stored in the memory to transmit an approval request to the first entity. Furthermore, the processor may execute program instructions stored in the memory to transmit to the second entity, data from the dataset corresponding to the first entity, based on receipt of an approval from the first entity, wherein the data is determined based on the candidate role. Further, the second entity may be configured to enable a transaction interface upon receipt of data from the dataset corresponding to the first entity. The transaction interface may be configured to identify a target sub-schema, from the super-schema library, corresponding to the second entity, and enable the second entity to execute a target action, from a set of actions, associated with the first entity, based on the data from the dataset associated with the second entity and the first entity, using the target sub-schema.

In another implementation, a method of sharing information between entities to enable a transaction, is illustrated in accordance with an embodiment of the invention. The method may comprise one or more steps to enable a super-schema library corresponding to a set of entities. The super-schema library is configured to maintain a set of schemas, wherein each schema comprises a set of sub-schemas, wherein each sub-schema corresponds to a dataset associated with an entity, wherein the dataset comprises data corresponding to each role, from a set of roles, associated with the entity. The method may further comprise one or more steps to receive a first request from a first entity to initiate a transaction with a second entity. The method may further comprise one or more steps to transmit the request to the second entity. The method may comprise one or more steps to receive a second request, from the second entity, to access a dataset corresponding to the first entity. The second request may comprise a candidate role defining the relationship between the first entity and the second entity. The method may further comprise one or more steps to determine a candidate sub-schema from the super-schema library based on the candidate role, wherein the candidate sub-schema is associated with the first entity. The method may further comprise one or more steps to transmit an approval request to the first entity. Furthermore, the method may comprise one or more steps to transmit to the second entity, data from the dataset corresponding to the first entity, based on receipt of an approval from the first entity, wherein the data is determined based on the candidate role. Further, the second entity is configured to enable a transaction interface upon receipt of data from the dataset corresponding to the first entity. The transaction interface may be configured to identify a target sub-schema, from the super-schema library, corresponding to the second entity, and enable the second entity to execute a target action, from a set of actions, associated with the first entity, based on the data from the dataset associated with the second entity and the first entity, using the target sub-schema.

In another implementation, a computer program product having a processor and a non-transitory, machine-readable storage medium for information between entities to enable a transaction, is illustrated in accordance with an embodiment of the invention. The computer program product comprises a program code to enable a super-schema library corresponding to a set of entities. The super-schema library is configured to maintain a set of schemas, wherein each schema comprises a set of sub-schemas, wherein each sub-schema corresponds to a dataset associated with an entity. The dataset may comprise data corresponding to each role, from a set of roles, associated with the entity. Further, the computer program product may comprise a program code to receive a first request from a first entity to initiate a transaction with a second entity. The computer program product may comprise a program code to transmit the request to the second entity. The computer program product may comprise a program code to receive a second request, from the second entity, to access a dataset corresponding to the first entity, wherein the second request comprises a candidate role defining the relationship between the first entity and the second entity. The computer program product may comprise a program code to determine a candidate sub-schema from the super-schema library based on the candidate role, wherein the candidate sub-schema is associated with the first entity. The computer program product may comprise a program code to transmit an approval request to the first entity. Furthermore, the computer program product may comprise a program code to transmit to the second entity, data from the dataset corresponding to the first entity, based on receipt of an approval from the first entity, wherein the data is determined based on the candidate role. Further, the second entity is configured to enable a transaction interface upon receipt of data from the dataset corresponding to the first entity. The transaction interface may be configured to identify a target sub-schema, from the super-schema library, corresponding to the second entity, and enable the second entity to execute a target action, from a set of actions, associated with the first entity, based on the data from the dataset associated with the second entity and the first entity, using the target sub-schema.

### BRIEF DESCRIPTION OF DRAWINGS

The detailed description is described with reference to the accompanying Figures. The same numbers are used throughout the drawings to refer to like features and components.

FIG. 1 illustrates a network implementation of a system for sharing information between entities, in accordance with an embodiment of the present disclosure.

FIG. 2 illustrates components of the system for sharing information between entities, in accordance with an embodiment of the present disclosure.

FIG. 3 illustrates a method for sharing information between entities to enable a transaction, in accordance with an embodiment of the present disclosure.

### DETAILED DESCRIPTION

Reference throughout the specification to “various embodiments,” “some embodiments,” “one embodiment,” or “an embodiment” means that a particular feature, structure, or characteristic described in connection with the embodiment is included in at least one embodiment. Thus, appearances of the phrases “in various embodiments,” “in some embodiments,” “in one embodiment,” or “in an embodiment” in places throughout the specification are not necessarily all referring to the same embodiment. Furthermore, the particular features, structures or characteristics may be combined in any suitable manner in one or more embodiments.

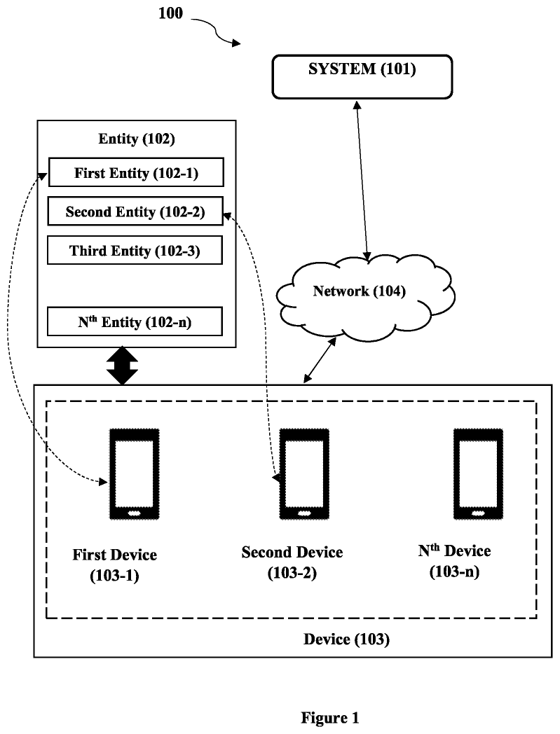

Referring to FIG. 1, implementation 100 of system 101 for sharing information between two or more entities from a set of entities 102 to enable a transaction is illustrated, in accordance with an embodiment of the present subject matter. The set of entities 102 may comprise people, devices, or representatives of an organization. In one embodiment, the system 101 may enable communication between two individuals for example between a patient and a doctor. The system 101 may also enable communication between an individual and a device for example a user and a smart TV. The system 101 may also enable communication between two organizations for example a service provider and a client. The set of entities 102 may use a set of devices 103 to establish communication with each other. For the purpose of communication and interoperability between any two entities, the system 101 may enable schemas. The schemas make it possible to transform the current state of the world of devices into one where any entity can communicate with any other entity, regardless of what kind of devices the entities are using, as long as both the devices are connected to the same communication network and run an application compatible with the schemas.

In one embodiment, the system 101 may comprise a processor and a memory. Further, the system 101 may be connected to the set of entities 102 through a network 104. It may be understood that the system 101 may be communicatively coupled with the set of entities 102 through one or more devices 103-1, 103-2, 103-3 . . . , 103-n collectively referred to as devices 103. In one embodiment, an entity from the set of entities 102 may be any electronic device such as a vehicle, a smart TV, a refrigerator in which case the entity and device may act as a single unit and directly communicate with other entities or devices associated with different entities in the network 104.

In one embodiment, the network 104 may be a cellular communication network used by devices 103 such as mobile phones, tablets, virtual devices, electronic devices, communication devices, machines, softwares, automated computer programs, robots or a combination thereof. In one embodiment, the cellular communication network may be the Internet. The devices 103 may enable interaction between a first entity 102-1 and a second entity 102-2 from the set of entities 102. The first entity 102-1 and the second entity 102-2 may be users of a social networking platform such as social media friends, or colleagues who are willing to communicate with each other. The second entity 102-2 may also be a third-party device such as a TV, smart home system, or car that is requesting data associated with the first entity 102-1 in order to enable the first entity 102-1 to control the second entity 102-2. The communication between the first entity and the second entity may be enabled with the help of the devices 103.

In one embodiment, the devices 103 may support communication over one or more types of networks in accordance with the described embodiments. For example, some devices and networks may support communications over a Wide Area Network (WAN), the Internet, a telephone network (e.g., analog, digital, POTS, PSTN, ISDN, xDSL), a mobile telephone network (e.g., CDMA, GSM, NDAC, TDMA, E-TDMA, NAMPS, WCDMA, CDMA-2000, UMTS, 3G, 4G), a radio network, a television network, a cable network, an optical network (e.g., PON), a satellite network (e.g., VSAT), a packet-switched network, a circuit-switched network, a public network, a private network, and/or other wired or wireless communications network configured to carry data. The aforementioned devices 103 and network 104 may support wireless local area network (WLAN) and/or wireless metropolitan area network (WMAN) data communications functionality in accordance with Institute of Electrical and Electronics Engineers (IEEE) standards, protocols, and variants such as IEEE 802.11 (“WiFi”), IEEE 802.16 (“WiMAX”), IEEE 802.20x (“Mobile-Fi”), and others.

In one embodiment, in order to enable communication between the first entity 102-1 and the second entity 102-2, from the set of entities 102, the system 101 is configured for enabling a super-schema library corresponding to the set of entities 102. The super-schema library is configured to maintain a set of schemas. Each schema from the super-schema library may comprise a set of sub-schemas. Furthermore, each sub-schema may correspond to a dataset associated with an entity. The dataset may comprise data corresponding to each role, from a set of roles, associated with the entity.

In one embodiment, each schema from the set of schemas may be associated with one or more entity classes. Each entity class may correspond to a subset of entities. For example, an entity class may correspond to cars, bikes, entertainment devices, communication devices, or the like. Furthermore, each entity from the subset of entities is linked to a sub-schema. The sub-schema is a collection of parameters defining the way in which data is organized, received and communicated by an entity. Furthermore, each sub-schema corresponds to a dataset associated with an entity, wherein the dataset comprises data corresponding to each role, from a set of roles, associated with that entity. The dataset may also correspond to predefined settings and privileges required by the entity in order to perform the set of actions.

In one embodiment, in order to generate the super-schema library, the system 101 may enable a schema platform. The schema platform may be an online platform which enables application developers to build the super-schema library. For this purpose, the schema platform may enable application developers to define a superset of attributes, wherein each attribute from the superset of attributes may be linked to a unique identification number. The superset of attributes may be updated from time to time based on the inputs from the application developers. Furthermore, one or more application developers may select a subset of attributes from the superset of attributes in order to build schemas and subschemas. The schemas and subschema may be used by the application developers to develop applications that enable communication with the devices 103. The applications may enable a transaction interface to execute a transaction between two or more entities. The collection of all the schemas developed by application developers is maintained as the super-schema library. Once the super-schema library is developed, the super-schema library can be used for enabling communication between any two entities depending on the role each entity is playing.

For example, in a communication between the first entity 102-1 and the second entity 102-2, the first entity 102-1 may take up different roles in different situations. In a hospital, the first entity 102-1 may be a patient, whereas in a restaurant, the first entity 102-1 may be a diner. Depending on the situation, the first entity 102-1 may execute a role of a patient, a diner, shopper, or the like. Each role associated with the entity may be linked to a sub-schema. Depending on the role, each sub-schema from the super-schema is linked with data, from the dataset, corresponding to a role associated with the first entity. For example, the first entity 102-1 with a role of a diner may be linked to data, from a dataset, corresponding to dietary preferences, food allergies, favorite cuisines and the like. In a similar manner, multiple roles may be defined for the first entity, each role may be linked with a sub-schema from the super-schema, and each sub-schema may be linked with the corresponding data in the dataset.

In a similar manner, the second entity 102-2 may be a user, an entertainment device, a car, and the like. In case the second entity 102-2 is an entertainment device, a dataset corresponding to volume controls of the entertainment device may be used by the first entity (driver) to control the volume of the entertainment device.

In one embodiment, in order to establish communication between the first entity 102-1 and the second entity 102-2, the system 101 is configured to receive a first request from the first entity 102-1 to initiate a transaction with the second entity 102-2. The first entity 102-1 may use the first device 103-1 in order to generate and send the first request to the second entity 102-2. The first request may be transmitted to the system 101 using the network 104. Further, the system 101 may transmit the first request to the second entity 102-2. The first request may indicate the intention of the first entity 102-1 to communicate with the second entity 102-2 in order to enable a transaction interface. If the second entity 102-2 desires to establish communication with the first entity 102-1, the second entity 102-2 may transmit a second request, to the system 101, to access a dataset corresponding to the first entity 102-1. The second request may comprise a candidate role defining the relationship between the first entity 102-1 and the second entity 102-2. For example, in case the first entity 102-1 is a patient and the second entity 102-2 is a doctor, the relationship between the first entity 102-1 and the second entity 102-2 is a patient-doctor relationship. Depending on the type of relationship between both the parties, one party can request data from the other party.

Furthermore, the system 101 may determine a candidate sub-schema from the super-schema library based on the candidate role, wherein the candidate sub-schema is associated with the first entity 102-1. The candidate sub-schema defines the extent of data that may be exchanged between both the parties.

Once the candidate sub-schema is identified, in the next step, the system 101 is configured to transmit an approval request to the first entity 102-1. Based on receipt of an approval from the first entity 102-1, the system 101 is configured to transmit to the second entity 102-2, data from the dataset corresponding to the first entity 102-1. In one embodiment, the data is determined based on the candidate role corresponding to the first entity 102-1.

Upon receipt of the data, the second entity 102-2 may be configured to enable a transaction interface. The transaction interface is configured to identify a target sub-schema, from the super-schema library, corresponding to the second entity 102-2. The transaction interface further enables the second entity 102-2 to execute a target action, from a set of actions, associated with the first entity based on the data from the dataset associated with the second entity 102-2 and first entity 102-1, using the target sub-schema corresponding to the second entity 102-2.

For example, in case the first entity 102-1 is a guest driver and the second entity 102-2 is a smart car, then the guest driver may be able to execute target entity actions such as operating driving controls, changing music settings, setting maximum vehicle speed, and the like. However, the guest driver may not be allowed to access the storage compartments in the smart car.

The guest driver may send a first request to the system 101 to access the smart car. The first request may be generated with the help of a device 103-1 associated with the guest driver. The device 103-1 associated with the guest driver may be a mobile phone of the guest driver. The mobile phone may be operated by the guest driver to generate the first request to access the smart car. Upon receipt of the first request, the system 101 may transmit the first request to the smart car. Upon receipt of the first request, the smart car may generate a second request to fetch data corresponding to the guest driver. The request may be accompanied with a candidate role defining the relationship between the guest driver and the smart car. Based on the candidate role, the system 101 is configured for determining a candidate sub-schema from the super-schema.

In this example, where the first entity 102-1 is performing the role of a guest driver, the information related to the guest driver such as seat configuration, music preferences, temperature settings and the like may be transferred to the second entity 102-2 (smart car). Due to this structured approach, only the information required by the second entity 102-2 (smart car) is transmitted to the second entity 102-2.

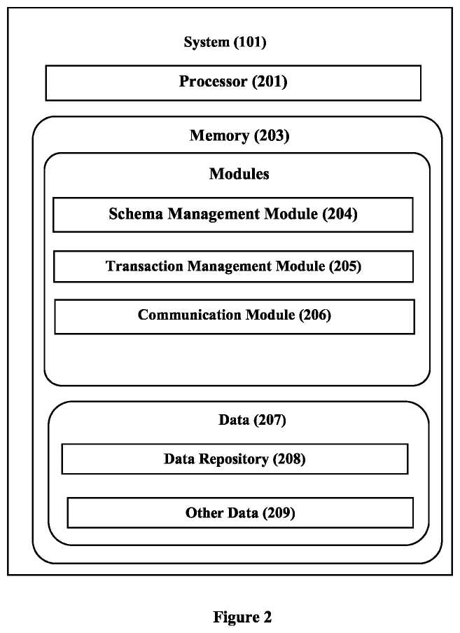

In this example, where the candidate role of the first entity 101-2 is that of a guest driver, a target sub-schema, from the super-schema library, corresponding to the second entity (smart car) is identified. The target sub-schema may be associated with parameters such as seat configuration, music preferences, temperature settings, and the like. It must be noted that the target sub-schema may not include attributes to access the speed limit setting since this parameter can only be controlled by the vehicle owner. Further, the second entity 102-2 is enabled to execute a target action (unlock the smart car), from a set of actions, associated with the first entity 102-1 based on the data from the dataset associated with the second entity 102-2 and first entity 102-1, using the target sub-schema corresponding to the second entity 102-2. The establishment of communication between the first entity 102-1 and the second entity 102-2 is further illustrated with reference to the block diagram in FIG. 2.

Referring now to FIG. 2, various components of the system 101 are illustrated, in accordance with an embodiment of the present subject matter. As shown, the system 101 may include at least one processor 201 and a memory 203. The memory comprises a set of modules. The set of modules may include a schema management module 204, a transaction management module 205, and a communication module 206. In one embodiment, the at least one processor 201 is configured to fetch and execute computer-readable instructions, stored in the memory 203, corresponding to each module.

In one embodiment, the memory 203 may include any computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and memory cards.

In one embodiment, the programmed instructions may include routines, programs, objects, components, data structures, etc., which perform particular tasks, functions, or implement particular abstract data types. The data 207 may comprise a data repository 208, and other data 209. The other data 209 amongst other things, serves as a repository for storing data processed, received, and generated by one or more components and programmed instructions. The working of the system 101 will now be described in detail referring to FIGS. 1 and 2.

In one embodiment, the processor 201 may be configured for executing programmed instructions corresponding to schema management module 204 for maintaining a super-schema library corresponding to a set of entities over the system 101. The super-schema library is configured to maintain a set of schemas. The super-schema library may be maintained in a repository. Each schema from the set of schemas may be linked to a dataset associated with a set of actions. The actions may correspond to one or more actions linked with the entity, that an entity can control using the dataset. For example, in case if the schema corresponds to entertainment devices, the entity actions may correspond to control TV volume, change TV channel, change radio station, and the like. Furthermore, the super-schema library may be updated to add new entity schemas at regular intervals.

In one embodiment, the processor 201 may be configured for executing programmed instructions corresponding to schema management module 204 for maintaining a super-schema library over the system 101. The super-schema library corresponds to the set of entities. The super-schema library comprises sub-schemas. Each sub-schema is linked with a dataset corresponding to a role associated with an entity from the set of entities 102. For example, the role associated with the entity, from the set of entities, may be a diner, a driver, a TV controller, a guest, or the like. Each role has a unique set of attributes that are recorded in a sub-schema.

Further, the processor 201 may be configured for executing programmed instructions corresponding to schema management module 204 for updating the super-schema library to add a new sub-schema and edit the sub-schemas associated with the super-schema library. Each new sub-schema is generated, based on a new role acquired by the entity. If the entity acquires new skills associated with a particular role which is already part of the super-schema library, the sub-schema associated with that role is also updated with attributes associated with the new skills. Whenever the entity interacts with another entity, these sub-schemas enable the communication between both the entities.

In one embodiment, the processor 201 may be configured for executing programmed instructions corresponding to transaction management module 205 for receiving a first request from a first entity 102-1 to initiate a transaction with the second entity 102-2. In case the first entity 102-1 is a patient and the second entity 102-2 is a doctor, then the patient may use his device 103-1 to transmit the first request to initiate a transaction with the doctor.

Upon receipt of the first request from the patient, the transaction management module 205 may be configured to transmit the first request to the doctor (i.e. to the device 103-2 associated with the second entity 102-2).

Further, the transaction management module 205 may be configured to receive a second request, from the second entity, to access a dataset corresponding to the first entity 102-1 (patient). The second request may comprise a candidate role defining the relationship (patient:doctor) between the first entity 102-1 and the second entity 102-2. For example, in the patient-doctor relationship, the doctor may first want to know one or more attributes associated with the patient before accepting an appointment request from the patient. For this purpose, the second request comprising the candidate role of the doctor may be sent from the device 103-2 to the transaction management module 205.

Further, the transaction management module 205 may determine a candidate sub-schema from the super-schema library based on the candidate role. The candidate sub-schema is associated with the first entity. In the patient-doctor relationship, the way in which data needs to be organized is determined by the candidate sub-schema.

Furthermore, the transaction management module 205 may be configured to transmit an approval request to the first entity. In the patient-doctor example, the patient may be first asked for permission before transmitting data, from the dataset corresponding to the first entity, to the second entity.

In case the transaction management module 205 receives an approval from the first entity 102-1 (patient) to transmit data from the dataset, corresponding to the first entity, to the second entity 102-2 (doctor), then the transaction management module 205 may determine data from the dataset based on the relationship (patient:doctor). In this example, the data such as time since last visit, patient symptoms, emergency status and the like may be identified and transmitted to the device 103-2 of the doctor. Upon receipt of the data from the first entity 102-1 (patient), the second entity 102-2 (doctor) is configured to enable a transaction interface.

The transaction interface is configured to identify a target sub-schema, from the super-schema library, corresponding to the second entity 102-2 (doctor).

The transaction interface is configured to enable the second entity 102-2 to execute a target action, from a set of actions, associated with the first entity based on the data from the dataset associated with the second entity 102-2 and first entity 102-1, using the target sub-schema corresponding to the second entity 102-2.

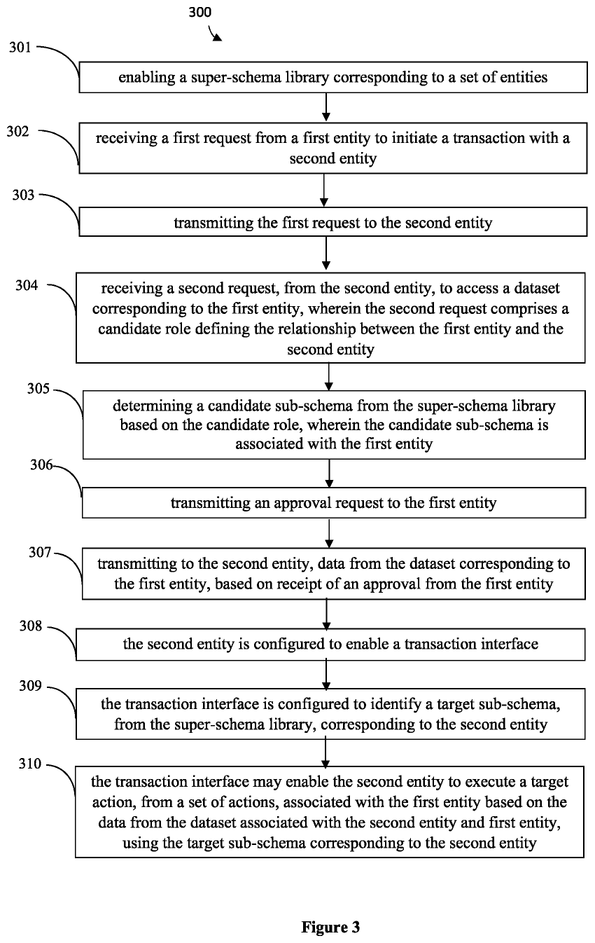

Now referring to FIG. 3, a method 300 for sharing information between entities is illustrated, in accordance with an embodiment of the present subject matter.

At step 301, the processor 201 may be configured to enable a super-schema library corresponding to a set of entities. The super-schema library is configured to maintain a set of schemas. Each schema, from the set of schemas, may comprise a set of sub-schemas. Each sub-schema may correspond to a dataset associated with an entity. Furthermore, the dataset may comprise data corresponding to each role, from a set of roles, associated with the entity from the set of entities. The super-schema library may be maintained in a repository. Further, the processor 201 may be configured for updating the super-schema library to add a new sub-schema and edit the sub-schemas associated with the super-schema. Each new sub-schema is generated, based on a new role acquired by the entity. If the entity acquires new attributes associated with a particular role which is already part of the super-schema, the sub-schema associated with that role is also updated with the new attributes. Whenever the entity interacts with another entity, these sub-schemas enable the communication between the two entities.

At step 302, the processor 201 may be configured for receiving a first request from a first entity to initiate a transaction with a second entity.

At step 303, the processor 201 may be configured for transmitting the first request to the second entity.

At step 304, the processor 201 may be configured for receiving a second request, from the second entity, to access a dataset corresponding to the first entity. The second request comprises a candidate role defining the relationship between the first entity and the second entity.

At step 305, the processor 201 may be configured for determining a candidate sub-schema from the super-schema library based on the candidate role. The candidate sub-schema is associated with the first entity.

At step 306, the processor 201 may be configured for transmitting an approval request to the first entity.

At step 307, the processor 201 may be configured for transmitting, to the second entity, data from the dataset corresponding to the first entity, based on receipt of an approval from the first entity. The data is determined based on the candidate role.

At step 308, the second entity is configured to enable a transaction interface.

At step 309, the transaction interface is configured to identify a target sub-schema, from the super-schema library, corresponding to the second entity.

At step 310, the transaction interface may enable the second entity to execute a target action, from a set of actions, associated with the first entity based on the data from the dataset associated with the second entity and first entity, using the target sub-schema corresponding to the second entity.

The proposed system is explained with the following examples:

### Example 1

The proposed system 101 may enable communication between a First Entity 102-1 (diner) and a Second Entity 102-2 (Restaurant).

At step 1, the system 101 may enable a super-schema library corresponding to a set of entities including the diner and the restaurant.

At step 2, the system 101 may receive a first request from the diner to initiate a transaction with the restaurant. For this purpose, the diner may enter the restaurant and use her device 103-1 to transmit a request to the system 101.

At step 3, the system 101 may transmit the first request to the restaurant.

At step 4, the system 101 may receive a second request, from the restaurant, to access a dataset corresponding to the diner, wherein the request comprises a relationship (diner:restaurant) defining the relationship between the diner and the restaurant.

At step 5, the system 101 may determine a candidate sub-schema (metadata: allergies, food preferences, seating preference and so on) from the super-schema library based on the candidate role, wherein the candidate sub-schema is associated with the first entity.

At step 6, the system 101 may transmit an approval request to the diner.

At step 7, the system may transmit to the restaurant, requested data (allergies, food preferences) from the dataset corresponding to the diner, based on receipt of an approval from the diner, wherein the data is determined based on the relationship (diner:restaurant).

At step 8, a device 103-2 at the restaurant may be configured to enable a transaction interface.

At step 9, the transaction interface is configured to identify a target sub-schema (diner-menu), from the super-schema library, corresponding to the restaurant.

At step 10, the transaction interface is configured to enable the restaurant to execute a target action (receive entrée order), from a set of actions (order for beverage, appetizer, entrée, dessert), associated with the diner based on the requested data (allergies, food preferences) from the dataset associated with the diner, using the target sub-schema (diner-menu) corresponding to the restaurant.

### Example 2

The proposed system 101 may enable communication between two enterprises, for example an invoice-issue transaction between a service provider and a client.

At step 1, the system 101 may enable a super-schema library corresponding to a set of entities including the service provider and the client.

At step 2, the system 101 may receive a first request from the service provider to initiate a transaction with the client.

At step 3, the system 101 may transmit the first request to the client.

At step 4, the system 101 may receive a request, from the client, to access a dataset corresponding to the service provider, wherein the request comprises a candidate role defining the relationship between the two entities (service provider: client).

At step 5, the system 101 may determine a candidate sub-schema (bank account number, Tax ID Number, and so on) from the super-schema library based on the candidate role (service provider: client), wherein the candidate sub-schema (bank account number, Tax ID Number, and so on) is associated with the service provider.

At step 6, the system 101 may transmit an approval request to the service provider.

At step 7, the system 101 may transmit to the client, requested data (bank account number, tax identification number) from the dataset corresponding to the service provider, based on receipt of an approval from the service provider, wherein the data is determined based on the relationship (service provider: client).

At step 8, the client is configured to enable a transaction interface.

At step 9, the transaction interface is configured to identify a target sub-schema (invoice), from the super-schema library, corresponding to the client.

At step 10, the transaction interface is configured to enable the client to execute a target action (approve invoice), from a set of actions (review invoice, approve invoice, reject invoice, and so on), associated with the service provider based on the data (bank account number, tax identification number) from the dataset associated with the service provider, using the target sub-schema (invoice) corresponding to the client.

### Example 3

The proposed system 101 may enable communication between two individual users on a social network.

At step 1, the system 101 may enable a super-schema library corresponding to a set of entities.

At step 2, the system 101 may receive a first request from the first entity (post-viewer) to initiate a transaction with the second social network. For this purpose, the first entity may use her first social network to transmit a request to the system 101.

At step 3, the system 101 may transmit the first request to the second social network.

At step 4, the system 101 may receive a second request, from the second social network, to access a dataset corresponding to the first entity (post-viewer), wherein the request comprises a relationship (post-viewer:social network) defining the relationship between the first entity and the second social network.

At step 5, the system 101 may determine a candidate sub-schema (metadata: profanity filters, content preferences, layout preferences, and so on) from the super-schema library based on the candidate role, wherein the candidate sub-schema is associated with the first entity.

At step 6, the system 101 may transmit an approval request to the first entity.

At step 7, the system may transmit to the second social network, requested data (profanity filters, content preferences) from the dataset corresponding to the first entity, based on receipt of an approval from the first entity, wherein the data is determined based on the relationship (content-viewer:social network).

At step 8, the second social network device 103-2 may be configured to enable a transaction interface.

At step 9, the transaction interface is configured to identify a target sub-schema (viewer-content), from the super-schema library, corresponding to the second social network.

At step 10, the transaction interface is configured to enable the second social network to execute a target action (receive content request), from a set of actions (request for text, image, audio, video), associated with the post-viewer based on the requested data (profanity filters, content preferences) from the dataset associated with the post-viewer, using the target sub-schema (viewer-content) corresponding to the second social network.

Although implementations for the system 101 and the method 300 for sharing information between entities to enable a transaction, have been described in language specific to structural features and methods, it must be understood that the claims are not limited to the specific features or methods described. Rather, the specific features and methods are disclosed as examples of implementations for the system 101 and the method 300 for sharing information between entities to enable a transaction.

1. A system for sharing information between entities to enable a transaction, the system comprising:
a processor and a memory coupled to the processor, wherein the processor is configured to execute instructions stored in the memory for:
enabling a super-schema library corresponding to a set of entities, wherein the super-schema library is configured to maintain a set of schemas, wherein each schema comprises a set of sub-schemas, wherein each sub-schema corresponds to a dataset associated with an entity, wherein the dataset comprises data corresponding to each role, from a set of roles, associated with the entity;
receiving a first request from a first entity to initiate a transaction with a second entity;
transmitting the first request to the second entity;
receiving a second request, from the second entity, to access a dataset corresponding to the first entity, wherein the second request comprises a candidate role defining the relationship between the first entity and the second entity;
determining a candidate sub-schema from the super-schema library based on the candidate role, wherein the candidate sub-schema is associated with the first entity;
transmitting an approval request to the first entity; and
transmitting to the second entity, data from the dataset corresponding to the first entity, based on receipt of an approval from the first entity, wherein the data is determined based on the candidate role, wherein the second entity is configured to enable a transaction interface, wherein the transaction interface is configured to
identify a target sub-schema, from the super-schema library, corresponding to the second entity, and
enable the second entity to execute a target action, from a set of actions, associated with the first entity based on the data from the dataset associated with the second entity and first entity, using the target sub-schema corresponding to the second entity.

2. The system of claim 1, wherein the first entity and the second entity is a person, a device or a representative of an organization.

3. The system of claim 1, wherein the super-schema is updated to edit the sub-schemas associated with the super-schema or to add one or more new sub-schemas, wherein each new sub-schema is generated based on a new role required by the first entity or the second entity or based on change in attributes.

4. The system of claim 1, wherein the dataset corresponding to the first entity is checked for updates before transmission to the second entity.

5. The system of claim 1, wherein the super-schema library is maintained in a repository.

6. The system of claim 1, wherein the super-schema library is updated to add new entity schemas.

7. A method of sharing information between entities to enable a transaction, the method comprising processor implemented steps of:
enabling a super-schema library corresponding to a set of entities, wherein the super-schema library is configured to maintain a set of schemas, wherein each schema comprises a set of sub-schemas, wherein each sub-schema corresponds to a dataset associated with an entity, wherein the dataset comprises data corresponding to each role, from a set of roles, associated with the entity;
receiving a first request from a first entity to initiate a transaction with a second entity;
transmitting the first request to the second entity;
receiving a second request, from the second entity, to access a dataset corresponding to the first entity, wherein the second request comprises a candidate role defining the relationship between the first entity and the second entity;
determining a candidate sub-schema from the super-schema library based on the candidate role, wherein the candidate sub-schema is associated with the first entity;
transmitting an approval request to the first entity; and
transmitting to the second entity, data from the dataset corresponding to the first entity, based on receipt of an approval from the first entity, wherein the data is determined based on the candidate role, wherein the second entity is configured to enable a transaction interface, wherein the transaction interface is configured to
identify a target sub-schema, from the super-schema library, corresponding to the second entity, and
enable the second entity to execute a target action, from a set of actions, associated with the first entity based on the data from the dataset associated with the second entity and first entity, using the target sub-schema corresponding to the second entity.

8. The method of claim 7, wherein the first entity and the second entity is a person, a device or a representative of an organization.

9. The method of claim 7, wherein the super-schema is updated to edit the sub-schemas associated with the super-schema or add one or more new sub-schemas, wherein each new sub-schema is generated based on a new role required by the first entity or the second entity.

10. The method of claim 7, wherein the dataset corresponding to the first entity is checked for updates before transmission to the second entity.

11. The method of claim 7, wherein the super-schema library is maintained in a repository.

12. The method of claim 7, wherein the super-schema library is updated to add new entity schemas.

13. A computer program product having a processor and a non-transitory, machine-readable storage medium for sharing information between entities to enable a transaction, the computer program product comprising:
a program code for:
enabling a super-schema library corresponding to a set of entities, wherein the super-schema library is configured to maintain a set of schemas, wherein each schema comprises a set of sub-schemas, wherein each sub-schema corresponds to a dataset associated with an entity, wherein the dataset comprises data corresponding to each role, from a set of roles, associated with the entity;
receiving a first request from a first entity to initiate a transaction with a second entity;
transmitting the first request to the second entity;
receiving a second request, from the second entity, to access a dataset corresponding to the first entity, wherein the second request comprises a candidate role defining the relationship between the first entity and the second entity;
determining a candidate sub-schema from the super-schema library based on the candidate role, wherein the candidate sub-schema is associated with the first entity;
transmitting an approval request to the first entity; and
transmitting to the second entity, data from the dataset corresponding to the first entity, based on receipt of an approval from the first entity, wherein the data is determined based on the candidate role, wherein the second entity is configured to enable a transaction interface, wherein the transaction interface is configured to
identify a target sub-schema, from the super-schema library, corresponding to the second entity, and
enable the second entity to execute a target action, from a set of actions, associated with the first entity based on the data from the dataset associated with the second entity and first entity, using the target sub-schema corresponding to the second entity.
